(19) United States
(12) Patent Application Publication
(10) Pub. No.: US 2019/0338084 A1
(43) Pub. Date: Nov. 7, 2019

(54) MASTER BATCH PRODUCTION METHOD

(71) Applicants: SUMITOMO RUBBER INDUSTRIES, LTD., Kobe-shi, Hyogo (JP); NIPPON PAPER INDUSTRIES CO., LTD., Tokyo (JP)

(72) Inventors: Sumiko MIYAZAKI, Kobe-shi, Hyogo (JP); Takafumi KAWASAKI, Tokyo (JP); Kotaro ITO, Tokyo (JP); Yusuke YASUKAWA, Tokyo (JP)

(73) Assignees: SUMITOMO RUBBER INDUSTRIES, LTD., Kobe-shi, Hyogo (JP); NIPPON PAPER INDUSTRIES CO., LTD., Tokyo (JP)

(21) Appl. No.: 16/480,139

(22) PCT Filed: Jan. 19, 2018
(86) PCT No.: PCT/JP2018/001640

§ 371 Date: Jul. 23, 2019

(30) Foreign Application Priority Data
Jan. 24, 2017 (JP) 2017-010273

(51) Int. Cl. C08J 3/22; C08L 7/00; B60C 1/00

(52) U.S. Cl. CPC C08J 3/22; C08L 7/00; C08J 2309/00; C08J 2307/02; B60C 1/00

(57) ABSTRACT

The present invention aims to provide a method for producing a masterbatch with improved rubber physical properties such as tensile strength at break, rigidity, and fuel economy at high productivity by enhancing the amount of fillers incorporated into rubber and the dispersibility of fillers in rubber, as well as related products. The present invention relates to a method for producing a masterbatch, including: step (1) of mixing a rubber latex having a zeta potential of −100 to −20 mV with a filler dispersion having a zeta potential of −120 to −10 mV to prepare a latex compound; step (2) of adjusting the zeta potential of the latex compound obtained in step (1) to −30 to 0 mV; and step (3) of solidifying the coagulum obtained in step (2) with an organic solvent.

### TECHNICAL FIELD

The present invention relates to a method for producing a masterbatch.

### BACKGROUND ART

It has been known in the prior art that fillers such as short fibers (e.g. aramid), microfibrillated plant fibers (e.g. cellulose fibers), and crystalline polymers (e.g. syndiotactic polybutadiene) may be incorporated into rubber compositions to reinforce the rubber compositions and enhance their modulus (complex modulus). However, such fillers have a strong tendency to self-aggregate and are poorly compatible with rubber components in many cases. For example, when microfibrillated plant fibers are introduced into and mixed with rubber latex, unfortunately, about 20% of the microfibrillated plant fibers are not incorporated into the rubber component but remain in the solution.

In masterbatches prepared by mixing rubber latex with fillers, the fillers tend to easily form aggregates. For example, tires formed from such masterbatches may suffer rapid wear, cracks, chipping, or separation between layers due to the formed aggregates, thereby possibly resulting in air leakage or loss of handling stability. Therefore, there has been a need to enhance the dispersibility of fillers in rubber in masterbatches.

In order to enhance the dispersibility of fillers in rubber in masterbatches to improve rubber physical properties, conventional methods include mixing rubber latex with fillers and adjusting the pH of the mixture to prepare a masterbatch. Other methods are disclosed, including, for example: methods of mixing a carbon black-containing slurry solution having a predetermined zeta potential with a rubber latex solution followed by coagulation and drying to prepare a wet masterbatch (see, for example, Patent Literature 1); methods of breaking the amide bonds in natural rubber latex and mixing the resulting latex with a slurry solution of inorganic filler to prepare a natural rubber masterbatch (see, for example, Patent Literature 2); methods of mixing a slurry of inorganic particles with a polymer latex having a surface potential of a sign opposite to that of the slurry of inorganic particles to produce a polymer composite (see, for example, Patent Literature 3); methods of mixing together aqueous dispersions of single components in which the particles have a surface charge of the same sign and a predetermined zeta potential, and the ratio between the zeta potentials of the particles of each dispersion is within a predetermined range, followed by coagulating the resulting mixed dispersion (see, for example, Patent Literature 4); methods of removing water from an aqueous dispersion containing rubber latex and a cellulose nanofiber with a predetermined average fiber width and having a predetermined solids concentration to prepare a rubber masterbatch (see, for example, Patent Literature 5); and methods of removing water from a mixture containing a resin emulsion and a fine cellulose fiber with a predetermined average fiber width and having a predetermined solids concentration to produce a composite (see, for example, Patent Literature 6).

### CITATION LIST

### Patent Literature

Patent Literature 1: JP 2010-209175 A

Patent Literature 2: JP 2004-99625 A

Patent Literature 3: JP 2006-348216 A

Patent Literature 4: JP S62-104871 A

Patent Literature 5: JP 2014-141637 A

Patent Literature 6: JP 2015-93882 A

### SUMMARY OF INVENTION

### Technical Problem

As described above, various methods have been studied to enhance the dispersibility of fillers in rubber in masterbatches to improve rubber physical properties. However, there is still room for further improvement in dispersibility of fillers and productivity of masterbatches.

The present invention aims to solve the above problems and provide a method for producing a masterbatch with improved rubber physical properties such as tensile strength at break, rigidity, and fuel economy at high productivity by enhancing the amount of fillers incorporated into rubber and the dispersibility of fillers in rubber, as well as related products.

### Solution to Problem

The present invention relates to a method for producing a masterbatch, the method including: step (1) of mixing a rubber latex having a zeta potential of −100 to −20 mV with a filler dispersion having a zeta potential of −120 to −10 mV to prepare a latex compound; step (2) of adjusting a zeta potential of the latex compound obtained in step (1) to −30 to 0 mV; and step (3) of solidifying a coagulum obtained in step (2) with an organic solvent.

The filler is preferably a microfibrillated plant fiber.

The rubber latex is preferably a diene rubber latex.

The present invention is also directed to a masterbatch, produced by the method.

The present invention is also directed to a rubber composition for tires, prepared from the masterbatch.

The present invention is also directed to a pneumatic tire, formed from the rubber composition.

### Advantageous Effects of Invention

The method for producing a masterbatch of the present invention includes: step (1) of mixing a rubber latex having a zeta potential of −100 to −20 mV with a filler dispersion having a zeta potential of −120 to −10 mV to prepare a latex compound; step (2) of adjusting the zeta potential of the latex compound obtained in step (1) to −30 to 0 mV; and step (3) of solidifying the coagulum obtained in step (2) with an organic solvent. Such a method further enhances the dispersibility of fillers in rubber to provide a masterbatch in which fillers are finely dispersed in rubber. Moreover, since the zeta potential of the latex compound is adjusted to −30 to 0 mV, and the resulting coagulum is solidified with an organic solvent, the amount of fillers incorporated into rubber is enhanced, and the coagulum is grown to a larger size without impairing the dispersibility of fillers in rubber, thereby enhancing filtration properties in the masterbatch production. Thus, productivity during the masterbatch production is further enhanced, and a masterbatch with further enhanced properties can be produced at high productivity. Then, such a masterbatch can be used to produce a rubber composition for tires and a pneumatic tire which have improved rubber physical properties such as tensile strength at break, rigidity, and fuel economy.

### DESCRIPTION OF EMBODIMENTS

### [Method for Producing Masterbatch]

The method for producing a masterbatch of the present invention includes: step (1) of mixing a rubber latex having a zeta potential of −100 to −20 mV with a filler dispersion having a zeta potential of −120 to −10 mV to prepare a latex compound; step (2) of adjusting the zeta potential of the latex compound obtained in step (1) to −30 to 0 mV; and step (3) of solidifying the coagulum obtained in step (2) with an organic solvent. The production method of the present invention may include other steps, provided it includes steps (1), (2), and (3). Steps (1), (2), and (3) each may be performed once or repeated multiple times.

It is usually difficult to uniformly disperse fillers in rubber in masterbatches. However, the present inventors have found that by the production method including steps (1), (2), and (3) in which the zeta potential of the latex compound obtained in step (1) is adjusted within a predetermined range of −30 to 0 mV, it is possible to reduce aggregation of fillers to finely and highly disperse the fillers in rubber, and also to improve rubber physical properties. Moreover, it has also been found that since the coagulum obtained in step (2) is solidified with an organic solvent, it is possible to enhance the amount of fillers incorporated into rubber and to grow the coagulum to a larger size without impairing the dispersibility of fillers in rubber, thereby enhancing filtration properties in the masterbatch production. Therefore, a masterbatch with further enhanced properties can be produced at high productivity.

### (Step (1))

According to the present invention, step (1) is first performed in which a rubber latex having a zeta potential of −100 to −20 mV is mixed with a filler dispersion having a zeta potential of −120 to −10 mV to prepare a latex compound.

Any rubber latex having a zeta potential within a range of −100 to −20 mV may be used. Suitable examples include diene rubber latexes such as natural rubber latex, modified natural rubber latexes (saponified natural rubber latex, epoxidized natural rubber latex, etc.), and synthetic diene rubber latexes (latexes of polybutadiene rubber (BR), styrene butadiene rubber (SBR), styrene isoprene butadiene rubber (SIBR), polyisoprene rubber, acrylonitrile butadiene rubber, ethylene vinyl acetate rubber, chloroprene rubber, vinylpyridine rubber, and butyl rubber, etc.). Thus, in one suitable embodiment of the present invention, the rubber latex is a diene rubber latex. These rubber latexes may be used alone, or two or more of these may be used in combination. To more suitably achieve the effects of the present invention, natural rubber latex, SBR latex, BR latex, and polyisoprene rubber latex are more preferred among these, with natural rubber latex being particularly preferred.

The zeta potential of the rubber latex can be adjusted by varying the concentration (rubber solids concentration).

To more suitably achieve the effects of the present invention, the rubber latex preferably has a zeta potential of −90 mV or higher, more preferably −80 mV or higher, particularly preferably −70 mV or higher, but preferably −30 mV or lower, more preferably −40 mV or lower, still more preferably −50 mV or lower, particularly preferably −60 mV or lower.

Herein, the zeta potential can be measured using the device and conditions described later in EXAMPLES.

Natural rubber latex, which is collected as sap of natural rubber trees such as hevea trees, contains water, proteins, lipids, inorganic salts, and other components as well as a rubber component. The gel fraction of the rubber is considered to be derived from a complex of various impurities therein. In the present invention, the natural rubber latex may be, for example, a raw latex (field latex) taken from hevea trees by tapping, or a concentrated latex prepared by concentration via centrifugation or creaming (e.g., purified latex, high ammonia latex prepared by adding ammonia in a conventional manner, or LATZ latex which has been stabilized with zinc oxide, TMTD, and ammonia).

Natural rubber latex contains honeycomb cells formed of proteins and phospholipids, and the cells tend to inhibit the incorporation of fillers into the natural rubber. It is therefore necessary to deal with this problem, e.g. by previously removing the cells in natural rubber latex by saponification before mixing the natural rubber latex with fillers. However, the production method of the present invention including steps (1), (2), and (3), particularly step (2) of adjusting the zeta potential of the latex compound obtained in step (1) to −30 to 0 mV, allows fillers to be finely dispersed in rubber, even in unsaponified natural rubber latex.

The rubber latex can be prepared by conventional methods, or it may be any commercial product. The rubber latex preferably has a rubber solids content (solids concentration) of 5% to 80% by mass. The solids concentration is more preferably 7% by mass or more, still more preferably 10% by mass or more. In view of dispersibility of fillers, it is also more preferably 70% by mass or less, still more preferably 60% by mass or less, particularly preferably 20% by mass or less.

The filler dispersion is prepared by dispersing a filler in a solvent. Any filler dispersion having a zeta potential within a range of −120 to −10 mV can be used. Suitable examples of the filler include silica, lignin, waste paper, walnuts, and microfibrillated plant fibers. These fillers may be used alone, or two or more of these may be used in combination. To more suitably achieve the effects of the present invention, microfibrillated plant fibers are particularly preferred among these. Usually, water is suitably used as the solvent. Examples of the solvent other than water include water-soluble alcohols, ethers, and ketones.

The zeta potential of the filler dispersion can be adjusted by varying the concentration (filler solids concentration) or the type of solvent.

To more suitably achieve the effects of the present invention, the zeta potential of the filler dispersion is preferably −110 mV or higher, more preferably −100 mV or higher, still more preferably −80 mV or higher, but is preferably −12 mV or lower, more preferably −15 mV or lower.

The microfibrillated plant fiber is preferably a cellulose microfibril to obtain good reinforcing properties. Any cellulose microfibril derived from naturally-occurring materials may be used. Examples include those derived from: resource biomass such as fruits, grains, and root vegetables; wood, bamboo, hemp, jute, and kenaf, and pulp, paper, or cloth produced therefrom; waste biomass such as agricultural waste, food waste, and sewage sludge; unused biomass such as rice straw, wheat straw, and thinnings; and celluloses produced by ascidians, acetic acid bacteria, or other organisms.

The microfibrillated plant fiber may be produced by any method (fibrillation process), such as by chemically treating the raw material of the cellulose microfibril with sodium hydroxide or other chemicals, followed by mechanically grinding or beating using a refiner, a twin screw kneader (twin screw extruder), a twin screw kneading extruder, a high pressure homogenizer, a media-agitating mill, a stone mill, a grinder, a vibration mill, a sand grinder, or other devices. With such a method, a substantially lignin-free microfibrillated plant fiber can be produced because lignin is separated from the raw material by the chemical treatment. Other methods include ultra-high pressure treatment of the raw material of the cellulose microfibril.

In view of tensile strength at break, the microfibrillated plant fiber preferably has an average fiber length of 5000 nm or less, more preferably 2000 or less. In view of workability, the average fiber length is also preferably 50 nm or more, more preferably 150 nm or more.

In view of tensile strength at break, the microfibrillated plant fiber preferably has a maximum fiber diameter of 1000 nm or less, more preferably 500 nm or less, still more preferably 30 nm or less. The lower limit of the maximum fiber diameter is not particularly limited.

The microfibrillated plant fiber preferably has a number average fiber diameter of 2 to 150 nm, more preferably 2 to 100 nm, still more preferably 2 to 10 nm, particularly preferably 2 to 5 nm. The microfibrillated plant fiber having a number average fiber diameter within the range indicated above can be uniformly dispersed.

The average fiber length, maximum fiber diameter, and number average fiber diameter of the microfibrillated plant fiber can be measured by known methods. For example, they may be analyzed as described in JP 2008-001728 A. Specifically, the maximum fiber diameter and number average fiber diameter may be calculated from the widths of 50 fibers measured by observing (3000 nm×3000 nm) the microfibrillated plant fiber fixed to a piece of mica with a scanning probe microscope (available from Hitachi High-Tech Science Corporation). The average fiber length may be determined from the observed image using WinROOF image analysis software (available from Mitani Corporation).

The microfibrillated plant fiber may be prepared by the above production method followed by further treatment such as oxidation or various chemical modifications, or may be prepared by treating, e.g., by oxidation or various chemical modifications, a cellulose material that is a naturally-occurring material usable as the raw material of the cellulose microfibril (e.g., resource biomass such as fruits, grains, and root vegetables; wood, bamboo, hemp, jute, and kenaf, and pulp, paper, or cloth produced therefrom; waste biomass such as agricultural waste, food waste, and sewage sludge; unused biomass such as rice straw, wheat straw, and thinnings; celluloses produced by ascidians, acetic acid bacteria, or other organisms, etc.), optionally followed by the above fibrillation process. For example, it may suitably be a microfibrillated plant fiber oxidized with an N-oxyl compound.

The microfibrillated plant fiber oxidized with an N-oxyl compound may suitably be a fiber having a cellulose I crystalline structure in which the primary hydroxy group on the sixth carbon atom of the pyranose ring of cellulose is surface-oxidized to a carboxy or aldehyde group or a salt thereof. Such specific microfibrillated plant fibers are disclosed in, for example, JP 2008-001728 A. The term “pyranose ring” refers to a six-membered hydrocarbon ring consisting of five carbon atoms and one oxygen atom. In the oxidation of cellulose with an N-oxyl compound, the primary hydroxy group on the sixth carbon atom of the pyranose ring of the cellulose is selectively oxidized. Specifically, natural cellulose is biosynthesized in the form of nanofibers which are gathered in large numbers by hydrogen bonding to form bundles of fibers. When such cellulose fibers are oxidized with an N-oxyl compound, the primary hydroxy group on the sixth carbon atom of the pyranose ring is selectively oxidized, and this oxidation occurs only on the surface of the microfibrils. As a result, carboxy groups are densely introduced only into the surface of the microfibrils. Since the carboxy groups carrying a negative charge repel each other, these microfibrils, when dispersed in water, are prevented from aggregating. Thus, the bundles of fibers are fibrillated into microfibrils to form cellulose nanofibers. In order to better achieve the effects of the present invention, it is preferred that the primary hydroxy group on the sixth carbon atom of the pyranose ring of cellulose is surface-oxidized to a carboxy group.

The combined amount of carboxy and aldehyde groups in the microfibrillated plant fiber oxidized with an N-oxyl compound is preferably 0.1 mmol/g or more, more preferably 0.2 mmol/g or more, but preferably 2.5 mmol/g or less, more preferably 2.2 mmol/g or less, based on the weight (absolute dry weight) of the cellulose fiber. When the combined amount is within the range indicated above, the nanofiber can be more uniformly dispersed.

In the present invention, the combined amount is expressed by the charge density of the microfibrillated plant fiber. The term “absolute dry weight” means that the cellulose fiber constitutes 100% of the total weight.

In particular, the amount of the carboxy groups is preferably 0.1 mmol/g or more, more preferably 0.2 mmol/g or more, but preferably 2.4 mmol/g or less, more preferably 2.1 mmol/g or less, based on the weight (absolute dry weight) of the cellulose fiber. The introduction of carboxy groups in an amount within the range indicated above causes electrical repulsion leading to fibrillation into microfibrils, with the result that nanofibers can be more uniformly dispersed.

The identification of the type I crystalline structure of the microfibrillated plant fiber oxidized with an N-oxyl compound and the determination of the amounts of aldehyde and carboxy groups (mmol/g) can be carried out by known methods. For example, these may be analyzed as described in JP 2008-001728 A.

The microfibrillated plant fiber oxidized with an N-oxyl compound may be prepared by, for example, a method including: an oxidation step in which natural cellulose as a raw material is oxidized by the action of an N-oxyl compound as an oxidation catalyst and a co-oxidant in water to obtain a reacted fiber; a purification step in which impurities are removed to obtain a water-impregnated reacted fiber; and a dispersing step in which the water-impregnated reacted fiber is dispersed in a solvent.

Firstly, in the oxidation step, a dispersion of natural cellulose in water is prepared. Examples of the natural cellulose include purified celluloses isolated from cellulose biosynthesis systems such as plants, animals, or gels produced by bacteria. The natural cellulose may be subjected to a treatment for increasing the surface area, such as beating. Natural celluloses isolated, purified, and then stored in a never-dried condition may also be used. The dispersion medium of the natural cellulose in the reaction is water, and the concentration of the natural cellulose in the aqueous reaction solution is usually about 5% or lower.

The N-oxyl compound which can be used as an oxidation catalyst for cellulose refers to a compound that can form nitroxyl radicals, and examples include heterocyclic nitroxyl radical-forming compounds having C1-C4 alkyl groups at the a positions of an amino group as represented by the following formula (1):

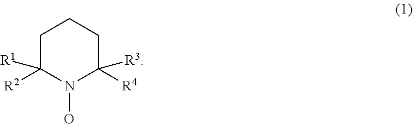

wherein R¹ to R⁴ are the same as or different from each other and each represent a C1-C4 alkyl group.

Preferred among the nitroxyl radical-forming compounds of formula (1) are 2,2,6,6-tetraalkylpiperidine-1-oxyl and derivatives thereof such as 4-hydroxy-2,2,6,6-tetraalkylpiperidine-1-oxyl, 4-alkoxy-2,2,6,6-tetraalkylpiperidine-1-oxyl, 4-benzoyloxy-2,2,6,6-tetraalkylpiperidine-1-oxyl, and 4-amino-2,2,6,6-tetraalkylpiperidine-1-oxyl. More preferred among these are 2,2,6,6-tetramethylpiperidine-1-oxyl (hereinafter, also referred to as TEMPO) and derivatives thereof such as 4-hydroxy-2,2,6,6-tetramethylpiperidine-1-oxyl (hereinafter, also referred to as 4-hydroxy TEMPO), 4-alkoxy-2,2,6,6-tetramethylpiperidine-1-oxyl (hereinafter, also referred to as 4-alkoxy TEMPO), 4-benzoyloxy-2,2,6,6-tetramethylpiperidine-1-oxyl (hereinafter, also referred to as 4-benzoyloxy TEMPO), and 4-amino-2,2,6,6-tetramethylpiperidine-1-oxyl (hereinafter, also referred to as 4-amino TEMPO). Derivatives of the foregoing compounds may also be used. Still more preferred among these is TEMPO because of its activity.

Examples of the derivatives of 4-hydroxy TEMPO include derivatives obtained by etherification of the hydroxy group of 4-hydroxy TEMPO with alcohols having a linear or branched carbon chain with four or less carbon atoms, and derivatives obtained by esterification of the hydroxy group of 4-hydroxy TEMPO with carboxylic or sulfonic acids, such as compounds represented by the following formulas (2) to (4):

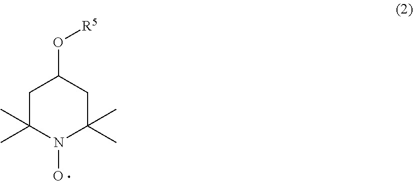

wherein R⁵ represents a linear or branched carbon chain with four or less carbon atoms,

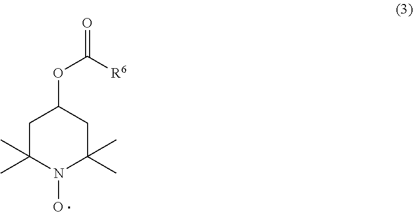

wherein R⁶ represents a linear or branched carbon chain with four or less carbon atoms, and

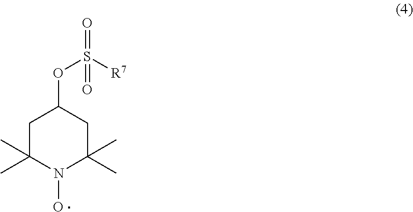

wherein R⁷ represents a linear or branched carbon chain with four or less carbon atoms.

Among the derivatives of 4-amino TEMPO, 4-acetamide TEMPO represented by the formula (5) below in which the amino group of 4-amino TEMPO is acetylated to provide moderate hydrophobicity is preferred because it is inexpensive and can produce a uniformly oxidized cellulose.

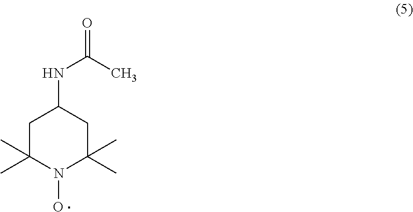

For efficient oxidation of cellulose in a short time, radicals of the N-oxyl compound represented by the formula (6) below, namely azaadamantane nitroxyl radicals are also preferred.

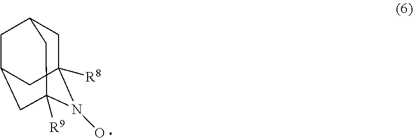

In formula (6), R⁸ and R⁹ are the same as or different from each other and each represent a hydrogen atom or a C1-C6 linear or branched alkyl group.

The N-oxyl compound may be added in any catalytic amount that allows for sufficient conversion of the resulting oxidized cellulose to nanofibers. The amount of the N-oxyl compound per gram (absolute dry weight) of the cellulose fiber is preferably 0.01 to 10 mmol/g, more preferably 0.01 to 1 mmol/g, still more preferably 0.025 to 0.5 mmol/g.

Examples of usable co-oxidants include hypohalous acids, halous acids, perhalic acids, and salts of these acids; hydrogen peroxide, and perorganic acids, preferably alkali metal salts of hypohalous acids. For example, when sodium hypochlorite is used, the reaction is preferably performed in the presence of an alkali metal bromide. The amount of the alkali metal bromide added per gram (absolute dry weight) of the cellulose fiber is preferably 0.1 to 100 mmol/g, more preferably 0.1 to 10 mmol/g, still more preferably 0.5 to 5 mmol/g, while the amount of the sodium hypochlorite added per gram (absolute dry weight) of the cellulose fiber is preferably 0.5 to 500 mmol/g, more preferably 0.5 to 50 mmol/g, still more preferably 2.5 to 25 mmol/g.

The pH of the aqueous reaction solution is preferably maintained within a range of about 8 to 11. The temperature of the solution is about 4 to 40° C., for example at room temperature, and it is not particularly necessary to control the temperature.

The amount of the co-oxidant added per gram (absolute dry weight) of the cellulose fiber is preferably within a range of about 3.0 to 8.2 mmol/g.

In the purification step, the compounds present in the reaction slurry other than the reacted fiber and water, such as unreacted hypochlorous acid and various by-products, are removed from the system. Common purification methods can be used. For example, a high purity (99% by mass or more) dispersion of the reacted fiber in water may be prepared by repeating water washing and filtration.

The purification step is followed by a dispersing treatment (dispersing step) in which the water-impregnated reacted fiber (aqueous dispersion) obtained in the former step is dispersed in a solvent to prepare a dispersion of the microfibrillated plant fiber. The solvent as a dispersion medium is usually preferably water. Examples of the solvent other than water include water-soluble alcohols, ethers, and ketones. Examples of dispersers that can be used in the dispersing step include powerful beating devices such as general dispersers, high speed rotary homomixers, and high pressure homogenizers. The microfibrillated plant fiber dispersion prepared as above can be used as the filler dispersion in the present invention. Moreover, the microfibrillated plant fiber dispersion may be dried to obtain the microfibrillated plant fiber oxidized with an N-oxyl compound, which may then be used as the filler in the present invention. The drying may be carried out by freeze drying, for example. In this process, the microfibrillated plant fiber dispersion may be mixed with, as a binder, a compound having a very high boiling point and an affinity for cellulose, such as a water-soluble polymer or saccharide to allow the microfibrillated plant fiber to be dispersed as a nanofiber again in a solvent even when it is dried in a common manner. In this case, the amount of the binder added to the dispersion is desirably within a range of 10 to 80% by mass of the amount of the reacted fiber.

The filler dispersion can be prepared by any method including known methods. For example, it may be prepared by dispersing the filler in the solvent using a high-speed homogenizer, ultrasonic homogenizer, colloid mill, blender mill, or other devices. The temperature and time during the preparation may be appropriately selected within usual ranges so that the filler can be sufficiently dispersed in the solvent.

The amount (solids content, solids concentration) of the filler in the filler dispersion is not particularly limited. In view of dispersibility of the filler in the dispersion, the amount of the filler based on 100% by mass of the filler dispersion is preferably 0.2% to 20% by mass, more preferably 0.3% to 10% by mass, still more preferably 0.4% to 5% by mass, particularly preferably 0.5% to 3% by mass.

In step (1), the mixing of the rubber latex with the filler dispersion is not particularly limited as long as it allows the rubber latex to be mixed with the filler dispersion. Other compounding agents, such as a binder, may further be added to the rubber latex and the filler dispersion.

In step (1), the rubber latex may be mixed with the filler dispersion by any method. Examples include: a method in which the rubber latex is placed and stirred in a known stirring device such as a high-speed homogenizer, ultrasonic homogenizer, colloid mill, or blender mill while dropwise adding the filler dispersion; a method in which the filler dispersion is placed and stirred in the known stirring device while dropwise adding the rubber latex; and a method in which the rubber latex and the filler dispersion are placed, stirred, and mixed in the known stirring device. In this manner, a latex compound can be prepared.

The latex compound preferably has a zeta potential of −90 mV or higher, more preferably −80 mV or higher, particularly preferably −70 mV or higher, but preferably −30 mV or lower, more preferably −40 mV or lower, still more preferably −50 mV or lower, particularly preferably −60 mV or lower. The latex compound having a zeta potential within the range indicated above will be stable with little degradation.

In step (1), the rubber latex is preferably mixed with the filler dispersion such that the amount of the filler is 5 to 150 parts by mass per 100 parts by mass of the rubber solids in the rubber latex. When the amount is 5 parts by mass or more, the effects of the present invention can be more suitably achieved. When the amount is 150 parts by mass or less, the dispersibility of the filler in the rubber can be further enhanced, so that the effects of the present invention can be more suitably achieved. The amount of the filler is more preferably 10 parts by mass or more, still more preferably 15 parts by mass or more, but is more preferably 100 parts by mass or less, still more preferably 70 parts by mass or less, further preferably 50 parts by mass or less, particularly preferably 30 parts by mass or less.

In step (1), in order to prepare a homogeneous latex compound, the temperature and time for mixing the rubber latex with the filler dispersion are preferably 10 to 40° C. for 3 to 120 minutes, more preferably 15 to 35° C. for 5 to 90 minutes.

In view of dispersibility of the solids in the latex compound, the total concentration of the solids in the latex compound (total solids content, total solids concentration) is preferably 0.5% by mass or more, more preferably 1% by mass or more, but is preferably 30% by mass or less, more preferably 10% by mass or less, still more preferably 5% by mass or less, based on 100% by mass of the latex compound.

### (Step (2))

In the present invention, step (1) is followed by step (2) of adjusting the zeta potential of the latex compound obtained in step (1) to −30 to 0 mV. By adjusting the zeta potential within the above range, it is possible to reduce aggregation of the filler to finely and highly disperse the filler in the rubber. The zeta potential is preferably −2 mV or lower, more preferably −5 mV or lower, but is preferably −20 mV or higher, more preferably −15 mV or higher, still more preferably −10 mV or higher.

In step (2) in the present invention, the zeta potential of the latex compound is adjusted to −30 to 0 mV. During this zeta potential adjusting process, a coagulation reaction of the latex compound naturally proceeds simultaneously. Herein, the expression “the zeta potential of the latex compound is adjusted to −30 to 0 mV in step (2)” means that the latex compound has a zeta potential within a range of −30 to 0 mV after a time period long enough to substantially allow the coagulation reaction of the latex compound to sufficiently proceed and complete in the zeta potential adjusting process.

In step (2), the zeta potential of the latex compound obtained in step (1) may be adjusted to −30 to 0 mV by any method, preferably by placing and stirring the latex compound in a stirring device while adding an acid and/or a salt, particularly preferably an acid and a salt. Moreover, in view of filler dispersibility, the acid and/or salt are/is preferably added stepwise, i.e., introduced stepwise (in portions of the total amount). In a particularly preferred embodiment, an acid is introduced stepwise and then a salt is introduced stepwise.

The amount of the acid and/or salt added may be determined while continuously or intermittently measuring the zeta potential of the latex compound.

Examples of the acid include formic acid, sulfuric acid, hydrochloric acid, and acetic acid. Examples of the salt include monovalent to trivalent metal salts such as sodium chloride, magnesium chloride, and calcium salts (calcium nitrate, calcium chloride, etc.). Calcium chloride is preferred among these.

Examples of the stirring device include known stirring devices such as high-speed homogenizers, ultrasonic homogenizers, colloid mills, blender mills, and electronically controlled stirrers. In view of filler dispersibility, it is preferred to use an electronically controlled stirrer. The conditions during the stirring may be appropriately selected within a usual range. In view of filler dispersibility, for example, the stirring speed is preferably 10 to 500 rpm, more preferably 50 to 200 rpm. The temperature and time for stirring are preferably 10 to 40° C. for 3 to 120 minutes, more preferably 15 to 35° C. for 5 to 90 minutes.

Upon adjusting the zeta potential of the latex compound to −30 to 0 mV in step (2), the temperature of the latex compound is preferably 10 to 40° C. in view of filler dispersibility. It is more preferably 35° C. or lower.

Also upon adjusting the zeta potential of the latex compound to −30 to 0 mV in step (2), a flocculant may be added to control the simultaneously proceeding coagulation (the size of coagulated particle aggregate). Examples of the flocculant include cationic polymers.

### (Step (3))

Step (2) results in formation of a coagulum (aggregates containing the coagulated rubber and the filler). In the present invention, step (2) is followed by step (3) of solidifying the coagulum obtained in step (2) with an organic solvent. Since the zeta potential of the latex compound is adjusted to −30 to 0 mV, and the resulting coagulum is further solidified with an organic solvent, the amount of fillers incorporated into rubber is enhanced, and the coagulum is grown to a larger size without impairing the dispersibility of fillers in rubber, thereby enhancing filtration properties in the masterbatch production. Thus, productivity during the masterbatch production is further enhanced, and a masterbatch with further enhanced properties can be produced at high productivity.

The coagulum obtained in step (2) may be solidified with an organic solvent by any method. An exemplary preferred solidification method includes placing the coagulum and an organic solvent in a stirring device, or adding the coagulum to a stirring device containing an organic solvent, followed by stirring and mixing them.

Examples of the stirring device include known stirring devices such as high-speed homogenizers, ultrasonic homogenizers, colloid mills, blender mills, and electronically controlled stirrers. The conditions during the stirring include, for example, a stirring speed of preferably 10 to 500 rpm, more preferably 50 to 200 rpm. Moreover, the temperature and time for stirring are preferably 10 to 40° C. for 3 to 120 minutes, more preferably 15 to 35° C. for 5 to 90 minutes.

Examples of the organic solvent include monovalent alcohols such as methanol, ethanol, 1-propanol, 2-propanol (IPA), and butanol; polyhydric alcohols such as ethylene glycol, propylene glycol, and butylene glycol; ketones such as acetone and methyl ethyl ketone; esters such as methyl acetate and ethyl acetate; ethers such as tetrahydrofuran and diethyl ether; polyethers such as polyethylene glycol; hydrogenated hydrocarbons such as dichloromethane, chloroform, and carbon tetrachloride; hydrocarbons such as hexane, cyclohexane, and petroleum ether; and aromatic hydrocarbons such as benzene and toluene. From safety and economic standpoints, alcohols and ketones are preferred among these, with monovalent alcohols and ketones being more preferred, with ethanol, IPA, and acetone being still more preferred, with ethanol or acetone being particularly preferred. Thus, in another suitable embodiment of the present invention, the organic solvent used in step (3) is ethanol or acetone.

A coagulum having a larger size is formed by step (3). The coagulum obtained in step (3) (aggregates containing the coagulated rubber and the filler) may optionally be filtered (e.g., through a 5 to 500 μm-aperture mesh) and dried by known methods, followed by rubber kneading using a kneading machine such as a two-roll mill or Banbury mixer to obtain a masterbatch in which the fillers are finely and highly dispersed in the rubber matrix. The masterbatch may contain other components as long as the effects of the present invention are not hindered.

### [Masterbatch]

The method for producing a masterbatch of the present invention includes: step (1) of mixing a rubber latex having a zeta potential of −100 to −20 mV with a filler dispersion having a zeta potential of −120 to −10 mV to prepare a latex compound; step (2) of adjusting the zeta potential of the latex compound obtained in step (1) to −30 to 0 mV; and step (3) of solidifying the coagulum obtained in step (2) with an organic solvent. Such a method further enhances the dispersibility of fillers in rubber to provide a masterbatch in which fillers are finely dispersed in rubber. Moreover, since the zeta potential of the latex compound is adjusted to −30 to 0 mV, and the resulting coagulum is solidified with an organic solvent, the amount of fillers incorporated into rubber is enhanced, and the coagulum is grown to a larger size without impairing the dispersibility of fillers in rubber, thereby enhancing filtration properties in the masterbatch production. Thus, productivity during the masterbatch production is further enhanced, and a masterbatch with further enhanced properties can be produced at high productivity. Then, such a masterbatch can be used to produce a rubber composition for tires and a pneumatic tire which have improved rubber physical properties such as tensile strength at break, rigidity, and fuel economy. Thus, in the masterbatch produced by the production method of the present invention, fillers are finely dispersed in rubber. Such a masterbatch produced by the production method is another aspect of the present invention.

### [Rubber Composition for Tires]

The rubber composition for tires of the present invention is prepared from the masterbatch. In the rubber composition combining the masterbatch, in which fillers are finely dispersed in rubber, with other components, the fillers can also be finely dispersed, thereby resulting in improved rubber physical properties such as excellent tensile strength at break, rigidity, and fuel economy.

In the rubber composition for tires of the present invention, the amount of the rubber derived from the masterbatch is preferably 5% by mass or more, more preferably 10% by mass or more, still more preferably 15% by mass or more based on 100% by mass of the rubber component in the rubber composition. When the amount is 5% by mass or more, the effects of the present invention can be more suitably achieved. The upper limit may be 100% by mass.

As described above, the rubber composition for tires of the present invention may contain a rubber not derived from the masterbatch. Non-limiting examples of such rubbers include natural rubber (NR), polybutadiene rubber (BR), styrene butadiene rubber (SBR), ethylene propylene diene rubber (EPDM), chloroprene rubber (CR), acrylonitrile butadiene rubber (NBR), and butyl rubber (IIR). Among these, NR, BR, and SBR are preferred, with NR and BR being more preferred. It is particularly preferred to use a combination of NR and BR.

Non-limiting examples of the natural rubber (NR) include those commonly used in the rubber industry, such as SIR20, RSS#3, and TSR20.

In the case where the rubber composition for tires of the present invention contains natural rubber as a rubber not derived from the masterbatch, the amount of the natural rubber based on 100% by mass of the rubber component in the rubber composition for tires of the present invention is preferably 5% by mass or more, more preferably 10% by mass or more, still more preferably 20% by mass or more. When the amount is 5% by mass or more, particularly excellent fuel economy can be obtained. The amount is also preferably 60% by mass or less, more preferably 50% by mass or less, still more preferably 45% by mass or less. When the amount is 60% by mass or less, particularly handling stability can be further enhanced.

Non-limiting examples of the polybutadiene rubber (BR) include those commonly used in the tire industry, such as high-cis polybutadiene rubbers, e.g., BR1220 available from Zeon Corporation and BR130B and BR150B both available from Ube Industries, Ltd.; modified polybutadiene rubbers, e.g., BR1250H available from Zeon Corporation; polybutadiene rubbers containing syndiotactic polybutadiene crystals, e.g., VCR412 and VCR617 both available from Ube Industries, Ltd.; and polybutadiene rubbers synthesized using rare earth catalysts, e.g., BUNA-CB25 available from Lanxess. These BRs may be used alone, or two or more of these may be used in combination.

The BR preferably has a cis content of 70% by mass or higher, more preferably 90% by mass or higher, still more preferably 97% by mass or higher.

Herein, the cis content (cis 1,4-linkage content) of the BR can be measured by infrared absorption spectrometry.

In the case where the rubber composition for tires of the present invention contains polybutadiene rubber as a rubber not derived from the masterbatch, the amount of the polybutadiene rubber based on 100% by mass of the rubber component in the rubber composition for tires of the present invention is preferably 5% by mass or more, more preferably 10% by mass or more, still more preferably 20% by mass or more. When the amount is 5% by mass or more, particularly excellent tensile strength at break can be obtained. The amount is also preferably 50% by mass or less, more preferably 40% by mass or less, still more preferably 30% by mass or less. When the amount is 50% by mass or less, particularly processability and fuel economy can be further enhanced.

In the rubber composition for tires of the present invention, the amount of the filler per 100 parts by mass of the rubber component is preferably 1 part by mass or more, more preferably 2 parts by mass or more, still more preferably 3 parts by mass or more, but is preferably 50 parts by mass or less, more preferably 30 parts by mass or less, still more preferably 20 parts by mass or less, particularly preferably 10 parts by mass or less. When the amount is 1 part by mass or more, the effects of the present invention can be more suitably achieved. When the amount is 50 parts by mass or less, the dispersibility of the filler can be further enhanced, so that the effects of the present invention can be more suitably achieved.

The rubber composition for tires of the present invention may appropriately contain, in addition to the masterbatch, additional rubbers commonly used in the tire industry, which are not derived from the rubber in the masterbatch, additional fillers (e.g., carbon black) commonly used in the tire industry, which are not derived from the filler in the masterbatch, and other various materials commonly used in the tire industry, such as silane coupling agents, zinc oxide, stearic acid, antioxidants, softeners, sulfur, and vulcanization accelerators.

In particular, the incorporation of carbon black into the rubber composition for tires provides a reinforcing effect. In addition, its combined use with the filler can synergistically and significantly enhance the dispersibility of the filler in the rubber composition for tires. Thus, in another suitable embodiment of the present invention, the rubber composition for tires contains carbon black.

Non-limiting examples of the carbon black include GPF, FEF, HAF, ISAF, and SAF. These carbon blacks may be used alone, or two or more of these may be used in combination.

The carbon black preferably has a nitrogen adsorption specific surface area (N₂SA) of 20 m²/g or more, more preferably 25 m²/g or more. The N₂SA is also preferably 200 m²/g or less, more preferably 150 m²/g or less, still more preferably 120 m²/g or less. A N₂SA of 20 m²/g or more can lead to a higher reinforcing effect, while a N₂SA of 200 m²/g or less can lead to further enhanced fuel economy.

Herein, the nitrogen adsorption specific surface area of the carbon black can be determined in accordance with the method A in JIS K 6217.

The amount of the carbon black per 100 parts by mass of the rubber component is preferably 5 parts by mass or more, more preferably 10 parts by mass or more, but is preferably 200 parts by mass or less, more preferably 150 parts by mass or less, still more preferably 100 parts by mass or less, particularly preferably 70 parts by mass or less. When the amount is within the range indicated above, better fuel economy can be obtained.

The rubber composition for tires can be prepared by known methods. For example, it may be prepared by kneading the masterbatch and various materials as described above using a rubber kneading machine such as an open roll mill or Banbury mixer, and vulcanizing the mixture.

### [Pneumatic Tire]

The rubber composition for tires of the present invention may be suitably used for pneumatic tires. Such pneumatic tires can be produced by usual methods using the rubber composition for tires. Specifically, the unvulcanized rubber composition for tires containing various materials as needed may be extruded into the shape of a tire component and then formed in a usual manner on a tire building machine to build an unvulcanized tire, which may then be heated and pressurized in a vulcanizer to produce a tire.

### EXAMPLES

The present invention will be specifically described with reference to, but not limited to, examples.

The chemicals used in the examples and comparative examples are listed below.

Bleached softwood kraft pulp: a product available from Nippon Paper Industries Co., Ltd.

TEMPO: 2,2,6,6-tetramethyl-1-piperidine-N-oxyradical (a compound of formula (1) wherein R¹ to R⁴ are methyl groups) available from Tokyo Chemical Industry Co., Ltd.

Sodium bromide: a product available from Wako Pure Chemical Industries, Ltd.

Sodium hypochlorite: a product available from Tokyo Chemical Industry Co., Ltd.

NaOH: NaOH available from Wako Pure Chemical Industries, Ltd.

Hydrogen peroxide solution: hydrogen peroxide solution available from Wako Pure Chemical Industries, Ltd.

Natural rubber latex: Hytex Latex (high ammonia type, solids concentration: 60% by mass) available from Nomura Trading Co., Ltd.

Microfibrillated plant fiber 1: the microfibrillated plant fiber prepared in Production Example 1 below (a microfibrillated plant fiber oxidized with TEMPO)

Natural rubber: TSR20

Polybutadiene rubber: BR150B (cis content: 97% by mass, ML₁₊₄ (100° C.): 40) available from Ube Industries, Ltd.

Carbon black: SHOBLACK N550 (N₂SA: 42 m²/g) available from Cabot Japan K.K.

Antioxidant: NOCRAC 6C (N-phenyl-N′-(1,3-dimethyl-butyl)-p-phenylenediamine, 6PPD) available from Ouchi Shinko Chemical Industrial Co., Ltd.

Zinc oxide: zinc oxide #2 available from Mitsui Mining & Smelting Co., Ltd.

Stearic acid: stearic acid beads “Tsubaki” available from NOF Corporation

Sulfur: Seimi Sulfur (oil content: 10%) available from Nippon Kanryu Industry Co., Ltd.

Vulcanization accelerator: NOCCELER NS (N-tert-butyl-2-benzothiazolesulfenamide, TBBS) available from Ouchi Shinko Chemical Industrial Co., Ltd.

### <Preparation of Microfibrillated Plant Fiber 1>

### Production Example 1

An amount in dry weight of 5.00 g of undried bleached softwood kraft pulp (mainly consisting of fibers having a diameter of more than 1000 nm), 39 mg of TEMPO, and 514 mg of sodium bromide were dispersed in 500 mL of water. To the dispersion was added a 15% by mass sodium hypochlorite aqueous solution such that the mixture contained 5.5 mmol of sodium hypochlorite per gram (absolute dry weight) of the pulp, followed by starting a reaction. The pH during the reaction was maintained at 10.0 by dropwise adding a 3M aqueous NaOH solution. The reaction was considered to be completed when the pH no longer changed. The reaction product was filtered through a glass filter and then subjected to five cycles of washing with plenty of water and filtration, thereby obtaining a water-impregnated reacted fiber with a solids content of 15% by mass.

Next, water was added to the reacted fiber to prepare a slurry with a solids content of 1% by mass.

To 4 g (absolute dry weight) of the oxidized cellulose were added 1.5 mL of 1M NaOH and 0.5 mL of 30% hydrogen peroxide solution, and the concentration was adjusted to 5% (w/v) by adding ultrapure water. Thereafter, the mixture was heated for two hours at 80° C. in an autoclave.

The unwashed alkali-hydrolyzed, oxidized cellulose was treated three times in an ultra high pressure homogenizer (processing pressure: 140 MPa) to obtain a transparent gel dispersion (microfibrillated plant fiber 1).

The combined amount of carboxy and aldehyde groups and the amount of carboxy groups in the microfibrillated plant fiber were 1.6 mmol/g and 1.5 mmol/g, respectively, based on the weight of the cellulose fiber. The maximum fiber diameter and the number average fiber diameter were 8.2 nm and 4.0 nm, respectively. The average fiber length was 470 nm.

The maximum fiber diameter and the number average fiber diameter were calculated from the widths of 50 fibers measured by observing (3000 nm×3000 nm) the microfibrillated plant fiber fixed to a piece of mica with a scanning probe microscope (available from Hitachi High-Tech Science Corporation). The average fiber length was determined from the observed image using WinROOF image analysis software (available from Mitani Corporation).

### <Preparation of Masterbatch>

### Example 1

The microfibrillated plant fiber 1 dispersion was diluted with water to a solids concentration of 0.5% by mass and then stirred for about five minutes with a high-speed homogenizer (“T50” available from IKA Japan, rotational speed: 8000 rpm) to give a homogeneous aqueous dispersion (an aqueous microfibrillated plant fiber dispersion, viscosity: 7 to 8 mPa·s).

The solids concentration (DRC) of the natural rubber latex was adjusted to 10% by mass, and then the aqueous dispersion prepared as above was added to the natural rubber latex such that the dry weight (solids content) of microfibrillated plant fiber 1 was 20 parts by mass per 100 parts by mass of the rubber solids in the natural rubber latex, followed by stirring and mixing at 25° C. for five minutes using a high-speed homogenizer (“T50” available from IKA Japan, rotational speed: 8000 rpm) to prepare a rubber latex dispersion (latex compound, total solids concentration: 2% by mass). Next, a 1% by mass formic acid aqueous solution was added to the latex compound with slow stirring (an electronically controlled stirrer “Eurostar” available from IKA Japan, rotational speed: 100 rpm) at 25° C. for five minutes to adjust the zeta potential to −30 mV. Subsequently, a 1% by mass calcium chloride aqueous solution was added to adjust the zeta potential to −10 mV to obtain a coagulum. The coagulum was placed in an electronically controlled stirrer “Eurostar” available from IKA Japan (rotational speed: 100 rpm), and ethanol was added thereto to an ethanol concentration in the system of 30% by mass, followed by slow stirring at 25° C. for five minutes, thereby obtaining a coagulum. This coagulum had a larger size than before the mixing with ethanol, as confirmed by visual observation. Then, the coagulum was filtered through a 200 μm-aperture mesh and dried at 80° C. for six hours to obtain masterbatch 1. The solids recovery rate after the filtration and drying was calculated using the equation below and found to be 97.9% by mass. [solids recovery rate (% by mass)]=[ (amount of solids after filtration and drying)/(amount of solids introduced)]×100 The term “amount of solids introduced” in the equation refers to the sum of the amount of the rubber solids in the natural rubber latex introduced and the amount of the solids of the microfibrillated plant fiber introduced.

The zeta potential was measured using the device and conditions described below.

Measurement device: zeta potential analyzer “ELS-PT” available from Otsuka Electronics Co., Ltd.

### Measurement Conditions:

A pH titrator was used.
pH titration mode
Solvent: water

### Temperature: 25° C.

Dielectric constant: 78.22

### Viscosity: 0.8663 cp

Refractive index: 1.3312

The zeta potentials of the natural rubber latex (solids concentration: 10% by mass), the aqueous dispersion of the microfibrillated plant fiber (solids concentration: 0.5% by mass), and the latex compound (total solids concentration: 2% by mass) measured as above were as follows.

Natural rubber latex (solids concentration: 10% by mass): −65 mV
Aqueous dispersion of microfibrillated plant fiber (solids concentration: 0.5% by mass): −40 mV
Latex compound (total solids concentration: 2% by mass): −60 mV

The dispersibility of the microfibrillated plant fiber in the rubber in masterbatch 1 was also observed with a scanning electron microscope (SEM), and it was confirmed that the microfibrillated plant fiber formed no aggregates and was finely dispersed in the rubber.

### Comparative Example 1

Comparative masterbatch 1 was prepared as in Example 1, except that after the coagulum was obtained by adjusting the zeta potential to −10 mV, mixing with ethanol was not performed but the coagulum was filtered through a 200 μm-aperture mesh. This filtration process took 5.5 times the time needed in Example 1 to achieve the same level of filtration as in Example 1.

The solids recovery rate after the filtration and drying was also calculated as in Example 1 and found to be 91.1% by mass, which was lower than that of Example 1. This suggests that a larger amount of the microfibrillated plant fiber flowed into the filtrate in Comparative Example 1 than in Example 1. Thus, it is demonstrated that Comparative Example 1 was inferior to Example 1 in the amount of the microfibrillated plant fiber incorporated into the rubber in the masterbatch.

### Example 2

Masterbatch 2 was prepared as in Example 1, except that a 1% by mass formic acid aqueous solution was added to the latex compound with slow stirring (Eurostar available from IKA Japan, rotational speed: 100 rpm) at 25° C. for five minutes to adjust the zeta potential to −10 mV, and subsequently a 1% by mass calcium chloride aqueous solution was added to adjust the zeta potential to −5 mV to obtain a coagulum.

The dispersibility of the microfibrillated plant fiber in the rubber in masterbatch 2 was also observed with a scanning electron microscope (SEM), and it was confirmed that the microfibrillated plant fiber formed no aggregates and was finely dispersed in the rubber.

### Comparative Example 2

The microfibrillated plant fiber 1 dispersion was diluted with water to a solids concentration of 0.5% by mass and then stirred for about five minutes with a high-speed homogenizer (“T50” available from IKA Japan, rotational speed: 8000 rpm) to give a homogeneous aqueous dispersion (an aqueous microfibrillated plant fiber dispersion, viscosity: 7 to 8 mPa·s).

The solids concentration (DRC) of the natural rubber latex was adjusted to 10% by mass, and then the aqueous dispersion prepared as above was added to the natural rubber latex such that the dry weight (solids content) of microfibrillated plant fiber 1 was 20 parts by mass per 100 parts by mass of the solids of the natural rubber latex, followed by stirring and mixing at 25° C. for about five minutes using a high-speed homogenizer (“T50” available from IKA Japan, rotational speed: 8000 rpm) to prepare a rubber latex dispersion (latex compound, total solids concentration: 2% by mass). Next, a 1% by mass formic acid aqueous solution was added to the latex compound with slow stirring (Eurostar available from IKA Japan, rotational speed: 100 rpm) at 25° C. for five minutes to adjust the pH (pH meter D51T available from Horiba, Ltd.) to 4 to obtain a coagulum (the zeta potential was also measured as in Example 1 and found to be −35 mV). The coagulum was placed in an electronically controlled stirrer “Eurostar” available from IKA Japan (rotational speed: 100 rpm), and ethanol was added thereto to an ethanol concentration in the system of 30% by mass, followed by slow stirring at 25° C. for five minutes, thereby obtaining a coagulum. Then, the coagulum was filtered through a 200 μm-aperture mesh and dried at 80° C. for six hours to obtain comparative masterbatch 2.

The dispersibility of the microfibrillated plant fiber in the rubber in comparative masterbatch 2 was also observed with a scanning electron microscope (SEM), and it was confirmed that there were some aggregates of the microfibrillated plant fiber, and the microfibrillated plant fiber was not sufficiently finely dispersed in the rubber.

### Comparative Example 3

Comparative masterbatch 3 was prepared as in Example 1, except that a 1% by mass formic acid aqueous solution was added to the latex compound with slow stirring (Eurostar available from IKA Japan, rotational speed: 100 rpm) at 25° C. for five minutes to adjust the zeta potential to −40 mV to obtain a coagulum.

The dispersibility of the microfibrillated plant fiber in the rubber in comparative masterbatch 3 was also observed with a scanning electron microscope (SEM), and it was confirmed that the microfibrillated plant fiber formed aggregates and was not finely dispersed in the rubber.

### Comparative Example 4

Comparative masterbatch 4 was prepared as in Example 1, except that a 1% by mass formic acid aqueous solution was added to the latex compound with slow stirring (Eurostar available from IKA Japan, rotational speed: 100 rpm) at 25° C. for five minutes to adjust the zeta potential to 10 mV to obtain a coagulum.

The dispersibility of the microfibrillated plant fiber in the rubber in comparative masterbatch 4 was also observed with a scanning electron microscope (SEM), and it was confirmed that the microfibrillated plant fiber formed aggregates and was not finely dispersed in the rubber.

### Example 3

Masterbatch 3 was prepared as in Example 1, except that acetone was added and mixed instead of adding and mixing ethanol. The coagulum obtained after mixing with acetone had a larger size than the coagulum obtained before mixing with acetone, as confirmed by visual observation.

The solids recovery rate after the filtration and drying was also calculated as in Example 1 and found to be 97.3% by mass.

The dispersibility of the microfibrillated plant fiber in the rubber in masterbatch 3 was also observed with a scanning electron microscope (SEM), and it was confirmed that the microfibrillated plant fiber formed no aggregates and was finely dispersed in the rubber.

### Example 4

Masterbatch 4 was prepared as in Example 1, except that 2-propanol was added and mixed instead of adding and mixing ethanol. The coagulum obtained after mixing with 2-propanol had a larger size than the coagulum obtained before mixing with 2-propanol, as confirmed by visual observation.

The solids recovery rate after the filtration and drying was also calculated as in Example 1 and found to be 96.9% by mass.

The dispersibility of the microfibrillated plant fiber in the rubber in masterbatch 4 was also observed with a scanning electron microscope (SEM), and it was confirmed that the microfibrillated plant fiber formed no aggregates and was finely dispersed in the rubber.

### <Preparation of Vulcanized Rubber Composition>

### Examples 1 to 4 and Comparative Examples 1 to 4

According to each formulation shown in Table 1, the chemicals other than the sulfur and vulcanization accelerator were kneaded using a 1.7 L Banbury mixer. Next, the sulfur and vulcanization accelerator were added and kneaded into the kneaded mixture using an open roll mill to obtain an unvulcanized rubber composition. The unvulcanized rubber composition was press-vulcanized at 170° C. for 15 minutes to obtain a vulcanized rubber composition. The vulcanized rubber compositions prepared as above were evaluated as described below. Table 1 shows the results.

### (Tensile Testing)

No. 3 dumbbell-shaped rubber specimens prepared from the vulcanized rubber compositions were subjected to tensile testing in accordance with JIS K 6251 “Rubber, vulcanized or thermoplastic—Determination of tensile stress-strain properties” to determine the tensile strength at break (TB (MPa)) of the vulcanized rubber compositions.

The TB of each formulation example is expressed as an index (index of tensile strength at break (TB index)) using the equation below, with Comparative Example 2 set equal to 100. A higher TB index indicates a higher tensile strength at break and better durability.

(TB index)=(TB of each formulation example)/(TB of Comparative Example 2)×100

### (Viscoelastic Testing)

The complex modulus E* (MPa) and loss tangent (tan δ) in the tire circumferential direction of specimens cut out of each formulation example (vulcanized rubber composition) were measured using a viscoelastic spectrometer VES (available from Iwamoto Seisakusho Co., Ltd.) at a temperature of 70° C., a frequency of 10 Hz, an initial strain of 10%, and a dynamic strain of 2%.

The E* and tan δ of each formulation example are expressed as indices (E* index, tan δ index) using the equations below, each with Comparative Example 2 set equal to 100. A higher E* index indicates higher rigidity and better handling stability. A higher tan δ index indicates better rolling resistance properties (fuel economy).

(E* index)=(E* of each formulation example)/(E* of Comparative Example 2)×100

(tan δ index)=(tan δ of Comparative Example 2)/(tan δ of each formulation example)×100

The term “tire circumferential direction” means the direction along which the vulcanized rubber composition was extruded.

TABLE 1

| | | | Comparative | | Comparative |
|---|---|---|---|---|---|
| | | Example 1 | Example 1 | Example 2 | Example 2 |
| Formulation | Masterbatch | Masterbatch 1 | Comparative | Masterbatch 2 | Comparative |
| (parts by mass) | | | Masterbatch 1 | | Masterbatch 2 |
| | (Natural rubber solids: 100 parts by mass) | 30 | 30 | 30 | 30 |
| | (Microfibrillated plant fiber: 20 parts by mass) | | | | |
| | Zeta potential [mV] adjusted in step (2) | −10 | −10 | −5 | −35 |
| | Solidification in step (3) | Solidification | — | Solidification | Solidification |
| | | with ethanol | | with ethanol | with ethanol |
| | Natural rubber | 45 | 45 | 45 | 45 |
| | Polybutadiene rubber | 30 | 30 | 30 | 30 |
| | Carbon black | 40 | 40 | 40 | 40 |
| | Antioxidant | 2 | 2 | 2 | 2 |
| | Zinc oxide | 2 | 2 | 2 | 2 |
| | Stearic acid | 2 | 2 | 2 | 2 |
| | Sulfur | 2 | 2 | 2 | 2 |
| | Vulcanization accelerator | 1 | 1 | 1 | 1 |
| Evaluation | TB index | 115 | 115 | 114 | 100 |
| | E * index | 110 | 105 | 111 | 100 |
| | tan δ index | 118 | 120 | 118 | 100 |
| | | Comparative | Comparative | | |
| | | Example 3 | Example 4 | Example 3 | Example 4 |
| Formulation | Masterbatch | Comparative | Comparative | Masterbatch 3 | Masterbatch 4 |
| (parts by mass) | | Masterbatch 3 | Masterbatch 4 | | |
| | (Natural rubber solids: 100 parts by mass) | 30 | 30 | 30 | 30 |
| | (Microfibrillated plant fiber: 20 parts by mass) | | | | |
| | Zeta potential [mV] adjusted in step (2) | −40 | 10 | −10 | −10 |
| | Solidification in step (3) | Solidification | Solidification | Solidification | Solidification |
| | | with ethanol | with ethanol | with acetone | with |
| | | | | | 2-propanol |
| | Natural rubber | 45 | 45 | 45 | 45 |
| | Polybutadiene rubber | 30 | 30 | 30 | 30 |
| | Carbon black | 40 | 40 | 40 | 40 |
| | Antioxidant | 2 | 2 | 2 | 2 |
| | Zinc oxide | 2 | 2 | 2 | 2 |
| | Stearic acid | 2 | 2 | 2 | 2 |
| | Sulfur | 2 | 2 | 2 | 2 |
| | Vulcanization accelerator | 1 | 1 | 1 | 1 |
| Evaluation | TB index | 95 | 90 | 115 | 114 |
| | E * index | 98 | 95 | 110 | 109 |
| | tan δ index | 97 | 98 | 117 | 118 |

Table 1 demonstrates that rubber physical properties, including tensile strength at break, rigidity, and fuel economy, were improved in the examples using a masterbatch produced by a method including: step (1) of mixing a rubber latex having a zeta potential of −100 to −20 mV with a filler dispersion having a zeta potential of −120 to −10 mV to prepare a latex compound; step (2) of adjusting the zeta potential of the latex compound obtained in step (1) to −30 to 0 mV; and step (3) of solidifying the coagulum obtained in step (2) with an organic solvent, as compared to Comparative Example 2. In addition, the rigidity of the examples was also further improved compared to Comparative Example 1. In contrast, poor tensile strength at break, rigidity, and fuel economy were exhibited in Comparative Examples 3 and 4 using a masterbatch prepared by adjusting the latex compound obtained in step (1) to have a zeta potential outside the range of −30 to 0 mV.

In particular, it was found that in Example 1 in which the coagulum obtained in step (2) was solidified with an organic solvent, when compared to Comparative Example 1 omitting the step of solidifying the coagulum obtained in step (2) with an organic solvent, the time needed to achieve the same level of filtration was greatly reduced, indicating significantly enhanced filtration properties; and the solids recovery rate after the filtration and drying was increased, indicating an enhanced amount of the filler incorporated into the rubber in the masterbatch. It was further found that in Example 1, the filler was finely dispersed in the rubber. As demonstrated by these results, when the coagulum obtained in step (2) is solidified with an organic solvent, the amount of fillers incorporated into rubber is enhanced, and filtration properties in the masterbatch production is enhanced without impairing the dispersibility of fillers in rubber. Thus, productivity during the masterbatch production is further enhanced, and therefore a masterbatch with further enhanced properties can be produced at high productivity.

1. A method for producing a masterbatch, the method comprising:
step (1) of mixing a rubber latex having a zeta potential of −100 to −20 mV with a filler dispersion having a zeta potential of −120 to −10 mV to prepare a latex compound;
step (2) of adjusting a zeta potential of the latex compound obtained in step (1) to −30 to 0 mV; and
step (3) of solidifying a coagulum obtained in step (2) with an organic solvent.

2. The method for producing a masterbatch according to claim 1,
wherein the filler is a microfibrillated plant fiber.

3. The method for producing a masterbatch according to claim 1,
wherein the rubber latex is a diene rubber latex.

4. A masterbatch, produced by the method according to claim 1.

5. A rubber composition for tires, prepared from the masterbatch according to claim 4.

6. A pneumatic tire, formed from the rubber composition according to claim 5.

7. The method for producing a masterbatch according to claim 2,
wherein the rubber latex is a diene rubber latex.

8. A masterbatch, produced by the method according to claim 2.

9. A masterbatch produced by the method according to claim 3.
